(19) United States
(12) Patent Application Publication
(10) Pub. No.: US 2007/0195045 A1
(43) Pub. Date: Aug. 23, 2007

(54) Liquid crystal display device

(75) Inventor: Takeshi Kaneki, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/707,877

(22) Filed: Feb. 20, 2007

(30) Foreign Application Priority Data
Feb. 23, 2006 (JP) 2006-046493

(51) Int. Cl. G09G 3/36

(52) U.S. Cl. 345/96

(57) ABSTRACT

The present invention allows a liquid crystal display device to perform an image display of high quality by suppressing lowering of image quality which is generated attributed to an AC driving method. In a liquid crystal display device of the present invention, each pixel includes a pixel electrode and a counter electrode. Assuming a state in which a video voltage of a potential higher than a potential of a counter voltage applied to the counter electrode is applied to the pixel electrode as a drive state of positive polarity and a state in which the video voltage of the potential lower than the potential of the counter voltage applied to the counter electrode is applied to the pixel electrode as a drive state of negative polarity, the drive circuit changes the drive state of each pixel, for every m(m≧1) frame, from the drive state of positive polarity to the drive state of the negative polarity or from the drive state of the negative polarity to the drive state of the positive polarity and, at the same time, inverts a phase of the drive state of each pixel for every N(N≧m) frame, and the drive circuit outputs gray scale correction display data which differs from inputted display data in the first frame immediately after the phase inversion.

### CROSS-REFERENCE TO RELATED APPLICATIONS

The disclosure of Japanese Patent Application No. 2006-46493 filed on Feb. 23, 2006 including the specification, drawings, and abstract is incorporated herein by reference in its entirety.

### BACKGROUND

1. Field of the Invention

The present invention relates to a liquid crystal display device, and more particularly to a liquid crystal display device which can realize an image display of high quality by suppressing lowering of an image quality which is generated attributed to an AC driving method.

2. Description of the Related Art

A liquid crystal display module is used as a display device of a high-definition color monitor of a computer or other information equipment or a display device of a television receiver set.

The liquid crystal display module basically includes a so-called liquid crystal display panel which sandwiches liquid crystal between two (a pair of) substrates, wherein at least one of the substrates is made of transparent glass or the like. By selectively applying a voltage to various electrodes for forming pixels formed on the substrate of the liquid crystal display panel, predetermined pixels are turned on and off. This liquid crystal display panel exhibits the excellent contrast performance and the high-speed display performance.

FIG. 6 is a block diagram showing the schematic constitution of a conventional liquid crystal display module.

The liquid crystal display module shown in FIG. 6 is constituted of a liquid crystal display panel 1, a gate driver part 2, a source driver part 3, a display control circuit 4, and a power source part 5.

The gate driver part 2 and the source driver part 3 are arranged at a peripheral portion of the liquid crystal display panel 1. The gate driver part 2 is constituted of a plurality of gate driver ICs which are arranged on one side of the liquid crystal display panel 1. Further, the source driver part 3 is constituted of a plurality of source driver ICs which are arranged on another side of the liquid crystal display panel 1.

The display control circuit 4 applies the timing adjustment suitable for a display by the liquid crystal display panel 1 such as alternation of data to display signals which are outputted from a display signal source such as a personal computer or a television receiver set (host side), converts the display signals into display data of a display file, and inputs the display data to the gate driver part 2 and the source driver part 3 together with a synchronous signal (clock signal).

The gate driver part 2 and the source driver part 3 supply a scanning voltage to scanning lines based on a control of the display control circuit 4, and supplies a video voltage to video lines thus displaying an image. The power source circuit 5 generates various voltages necessary for the liquid crystal display device.

FIG. 7 is a view showing an equivalent circuit of a pixel part of the liquid crystal display panel 1 shown in FIG. 6. The drawing corresponds to an actual geometric arrangement of pixels, wherein a plurality of sub pixels which are arranged in a matrix array in an effective display region (pixel part) are constituted such that each sub pixel includes one thin film transistor (TFT)

In FIG. 7, symbols DR, DG, DB indicate video lines (also referred to as drain lines or source lines), symbol G indicates scanning lines (also referred to as gate lines), symbols R, G, B indicate pixel electrodes (ITO1) of respective colors (red, green, blue), symbol ITO2 indicates a counter electrode (also referred to as a common electrode), symbol Clc indicates a liquid crystal capacitance equivalently indicative of a liquid crystal layer, and symbol Cstg indicates a holding capacitance generated between a common signal line (COM) and the source electrode.

In the liquid crystal display panel 1 shown in FIG. 6, drain electrodes of the thin film transistors (TFT) of the respective pixels which are arranged in the columnar direction are respectively connected to the video lines (DR, DG, DB), and the respective video lines (D) are connected to the source driver part 3 which supplies a video voltage corresponding to display data to the pixels arranged in the columnar direction.

Further, gate electrodes of the thin film transistors (TFT) of the respective pixels which are arranged in the row direction are respectively connected to the scanning lines (G), and the respective scanning lines (G) are connected to the gate driver part 2 which supplies a scanning voltage (positive or negative bias voltage) to the gate of the thin film transistor (TFT) for 1 horizontal scanning time.

In displaying the image on the liquid crystal display panel 1, the gate driver part 2 selects the scanning lines (G0, G1, . . . Gj, Gj+1) from above to below (in order of G0→G1, . . . ), while, during a selection period of some scanning lines, the source driver part 3 supplies a video voltage corresponding to the display data to the video lines (DR, DG, DB) thus applying the video voltage to the pixel electrodes (ITO1).

Here, the explanation is made on a premise that the liquid crystal display panel 1 is operated in a so-called normally black-displaying mode in which the larger the video voltage supplied to the respective pixels, the higher brightness is obtained.

The voltage supplied to the video lines (D) is applied to the pixel electrodes (ITO1) via the thin film transistors (TFT) and, finally, charges are supplied to holding capacitances (Cstg) and liquid crystal capacitances (Clc) so as to control liquid crystal molecules thus displaying the image.

The above-mentioned operation is explained hereinafter in conjunction with timing waveforms.

FIG. 8 is a view showing a voltage waveform outputted to the scanning line (G) from the gate driver part 2 and a voltage waveform of the video voltage (VD) on the video line outputted from the source driver part 3 in the liquid crystal display module shown in FIG. 6.

A clock (CL1) shown in FIG. 8 is a clock for controlling output timing, and the source-driver part 3 outputs the video voltage (VD in FIG. 8) corresponding to the display data to the video lines (DR, DG, DB) from a point of time that the clock (CL1) falls. Here, FIG. 8 shows the voltage waveform of the video voltage (VD) when white is displayed.

The video voltage (VD) supplied to the video lines (DR, DG, DB), to prevent a DC voltage from being applied to the liquid crystal capacitance (Clc) in FIG. 7, provides AC driving in which for everyone horizontal scanning period (1H), the polarity is changed over between the video voltage of a high potential with respect to a common voltage (VCOM) applied to a counter electrode (ITO2) (hereinafter referred to as video voltage of positive polarity (+)) and the video voltage of a low potential with respect to the common voltage (VCOM) (hereinafter referred to as video voltage of negative polarity (−)). Here, FIG. 8 illustrates a case in which a dot inversion method which constitutes one of a common symmetry method is adopted as such an AC driving method.

On the other hand, the gate driver part 2 applies the scanning voltage (VG) of a High level (hereinafter referred to as H level) to the scanning lines (G0, G1, . . . Gj, Gj+1 ) in order of vertical scanning during one horizontal scanning period (1H) thus bringing all thin film transistors (TFT) connected to the scanning lines into an ON state, that is, a selection state whereby the video voltage (VD) outputted from the source driver part 3 is applied to the liquid crystal capacitance (Clc) and the holding capacitance (Cstg).

To the contrary, when the scanning voltage (VG) of Low level (hereinafter referred to as L level) is applied to the scanning lines (G0, G1, . . . Gj, Gj+1), all thin film transistors (TFT) which are connected to the scanning lines (G0, G1, . . . Gj, Gj+1) are brought into an OFF state, that is, a non-selection state.

A waveform of the video voltage (VD) becomes, as shown in FIG. 8, dull in accordance with line resistances of the video lines (DR, DG, DB) and a time constant of the liquid crystal capacitance (Clc) in rising and falling steps of the video voltage (VD). Accordingly, after the video voltage (VD) assumes a sufficiently saturated state, the scanning voltage (VG) is set to a voltage of L level during a non-selection period from a voltage of H level during a selection period.

For example, in the horizontal scanning period (N) shown in FIG. 8, from a point of time that the video voltage (VD) of positive polarity is sufficiently saturated to a point of time that the clock (CL1) at which the video voltage (VD) of next horizontal scanning period (N+1) is outputted falls, a slight time difference (gate delay time: Tgd) is provided, and the scanning voltage (VG) is set to a voltage of L level from a voltage of H level.

3. Description of Related Arts

FIG. 9 is a schematic view which simply expresses the pixel polarity and the pixel voltage level of one pixel when white and black are alternately displayed for every vertical scanning period (hereinafter referred to as frame) in the conventional liquid crystal display module.

As shown in FIG. 9, the liquid crystal display module takes a pattern in which when the video voltage is changed in conformity with the alternating cycle of the liquid crystal that “white display” is performed in the negative polarity and “black display” is performed in positive polarity, the pixel voltage is biased to the positive polarity side (plus side) with respect to a common voltage (VCOM) and a direct current is applied to liquid crystal as an effective value.

Particularly, this pattern frequently appears when a motion-picture image is displayed, wherein a DC signal is always applied to the liquid crystal and hence, a display quality is lowered and, at the same time, a lifetime of the liquid crystal per se is lowered. Further, display data which changes white and black images alternately for every frame is frequently generated when an interlace (jumping) scanning signal such as a television signal is converted into progressive (sequential) scanning in liquid crystal driving. For example, when television images or DVD images are displayed and observed on a liquid crystal display module, a bias of a drive voltage of the liquid crystal is generated thus giving rise to the deterioration of an image quality.

FIG. 10 shows pixel polarity for every frame when a phase of the pixel polarity is inverted at a fixed cycle (period A, period B) in the AC driving method shown in FIG. 9.

In response to a phase inversion signal shown in FIG. 10, the pixel voltage of a first frame of the period A assumes positive polarity (+) and the period B starts with the voltage of negative polarity (−) and hence, to compare the pixel polarities of respective intervals of the period A and the period B, the period A and the period B take the positive polarity (+) and the negative polarity (−) opposite from each other in all frames.

Hereinafter, in this specification, this AC driving method is referred to as a phase inversion driving method.

FIG. 11 is a schematic view which simply expresses the pixel polarity and the pixel voltage level of one pixel when white and black are alternately displayed for every frame in this phase inversion driving method.

As shown in FIG. 11, due to the phase inversion driving method, the pixel voltage which is biased to the negative polarity side (minus side) from the common potential (VCOM) is biased to the positive polarity side (plus side) after the phase inversion.

In this manner, by performing the AC driving such that the pixel voltage is biased to the positive polarity side and the negative polarity side at a fixed cycle, it is possible to reduce the effective DC voltage applied to the liquid crystal as a result.

On the other hand, to focus on the pixel polarity of Nth frame and the pixel polarity of the first frame after the phase inversion changeover shown in FIG. 11, the pixel polarities of the positive polarity (plus (+)) are continued. The continuation of the same pixel polarities may take “[(−)→(−)]” or “[(+)→(+)]” depending on the changeover timing of the phase inversion.

Here, when the pixel polarities are continued, the liquid crystal driving (AC) condition is changed in appearance and hence, flickers (a phenomenon which increases brightness) occurs on a display screen as a byproduct.

The flickers occur at the changeover timing of the phase inversion signal shown in FIG. 10, that is, in the first frame immediately after rising or falling of the phase inversion signal. As a result, while the phase inversion driving has an advantageous effect of preventing the DC current from being applied to the liquid crystal, the phase inversion driving generates the flickers as the byproduct thus giving rise to a drawback that the display quality is lowered.

The present invention has been made to overcome the above-mentioned drawbacks of the related art and it is an object of the present invention to provide a technique which can perform an image display of high quality by suppressing the lowering of an image which is generated by an AC driving method in a liquid crystal display device.

The above-mentioned and other objects and novel featured of the present invention will become apparent based on the description of the specification and attached drawings.

### SUMMARY

To explain the summary of the typical inventions among inventions described in this specification, they areas follows.

(1) A liquid crystal display device includes a liquid crystal display panel having a plurality of pixels and a drive circuit which drives each pixel out of the plurality of pixels, each pixel including a pixel electrode and a counter electrode, wherein assuming a state in which a video voltage of a potential higher than a potential of a counter voltage applied to the counter electrode is applied to the pixel electrode as a drive state of positive polarity and a state in which the video voltage of the potential lower than the potential of the counter voltage applied to the counter electrode is applied to the pixel electrode as a drive state of negative polarity, the drive circuit changes the drive state of each pixel, for every m(m≧1) frame, from the drive state of positive polarity to the drive state of the negative polarity or from the drive state of the negative polarity to the drive state of the positive polarity and, at the same time, inverts a phase of the drive state of each pixel for every N(N≧m) frame. In such a liquid crystal display device, the drive circuit outputs gray scale correction display data which differs from inputted display data in the first frame immediately after the phase inversion.

(2) In the constitution (1), the gray scale correction display data is display data corresponding to gray scales lower than gray scales corresponding to the inputted display data.

(3) In the constitution (2), the difference between the inputted display data and the gray scale correction display data is set such that the display data of intermediate gray scales is larger than the high gray-scale display data or low gray-scale display data.

(4) In any one of constitutions (1) to (3), the liquid crystal display device includes a memory for storing a correction quantity for every inputted display data, and the drive circuit generates and outputs the gray scale correction display data by subtracting the correction quantity stored in the memory from the inputted display data.

(5) In any one of constitutions (1) to (3), the liquid crystal display device includes a memory which stores the gray scale correction display data for every inputted display data, and the drive circuit generates and outputs the gray scale correction display data by reading the gray scale correction display data corresponding to the inputted display data from the memory.

(6) In the constitutions (4) or (5), the memory is an EPROM.

(7) In any one of constitutions (1) to (6), the “m” is 1.

(8) In any one of constitutions (1) to (7), the counter voltage applied to the counter electrode is a fixed voltage.

(9) In any one of constitutions (1) to (8), the liquid crystal display panel includes a pair of substrates which sandwiches liquid crystal therebetween, and the pixel electrode and the counter electrode are formed on one substrate out of the pair of substrates.

To simply explain the advantageous effects obtained by typical inventions among the inventions described in this specification, they are as follows.

According to the liquid crystal display device of the present invention, it becomes possible to perform an image display of high quality by suppressing lowering of image quality which is generated attributed to an AC driving method.

### BRIEF DESCRIPTION OF THE DRAWINGS

FIG. 1 is a block diagram showing the schematic constitution of a display control circuit 4 of a liquid crystal display module of an embodiment 1 according to the present invention;

FIG. 2 is a graph showing a brightness change quantity of a first frame immediately after a phase inversion in the liquid crystal display module of the embodiment 1 of the present invention and a brightness change quantity of a first frame immediately after the phase inversion in a conventional liquid crystal display module;

FIG. 3 is a graph showing one example of the relationship between inputted display data and gray scale correction display data in the liquid crystal display module of the embodiment 1 according to the present invention;

FIG. 4 is a view which schematically expresses the pixel voltage and the pixel polarity of one pixel for every frame with respect to video voltages of white and black in the liquid crystal display module of the embodiment 1 according to the present invention;

FIG. 5 is a block diagram showing the schematic constitution of a display control circuit 4 of a liquid crystal display module of an embodiment 2 according to the present invention;

FIG. 6 is a block diagram showing the schematic constitution of a conventional liquid crystal display module;

FIG. 7 is a view showing an equivalent circuit of a pixel part of the liquid crystal display panel shown in FIG. 6;

FIG. 8 is a view showing a voltage waveform outputted to the scanning line from the gate driver part and a voltage waveform of the video voltage on the video line outputted from the source driver part in a conventional liquid crystal display module;

FIG. 9 is a schematic view which simply expresses the pixel polarity and the pixel voltage level of one pixel when white and black are alternately displayed for every frame in the conventional liquid crystal display module;

FIG. 10 shows pixel polarity for every frame when a phase of the pixel polarity is inverted at a fixed cycle (period A, period B) in the AC driving method shown in FIG. 9; and

FIG. 11 is a schematic view which simply expresses the pixel polarity and the pixel voltage level of one pixel when white and black are alternately displayed for every frame in a phase inversion driving method.

### DETAILED DESCRIPTION OF THE INVENTION

Hereinafter, embodiments of the present invention are explained in detail in conjunction with drawings.

Here, in all drawings for explaining embodiments, parts having identical functions are given same numerals, and their repeated explanation is omitted.

### Embodiment 1

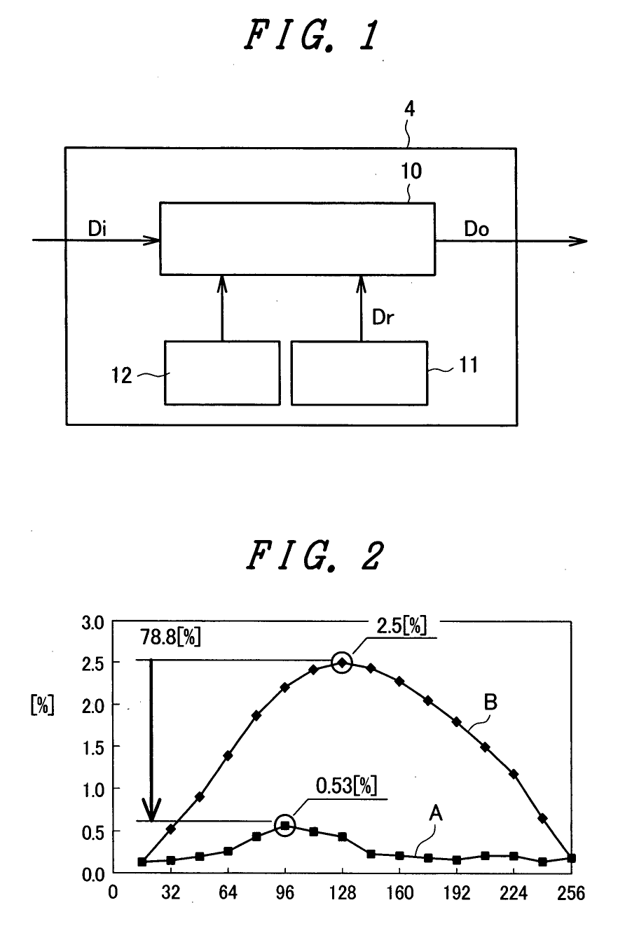

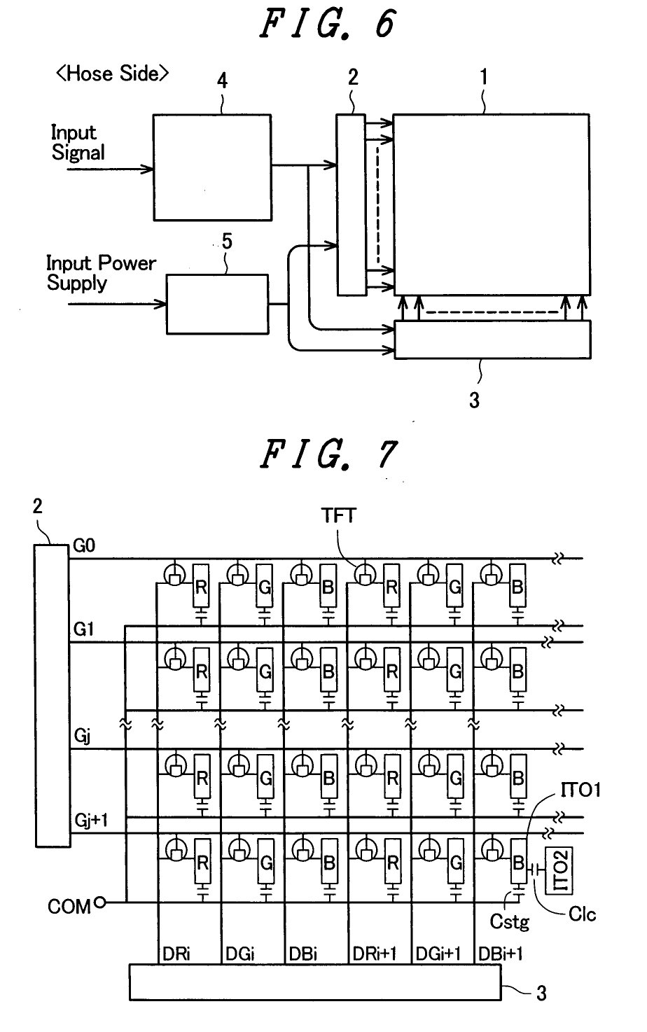

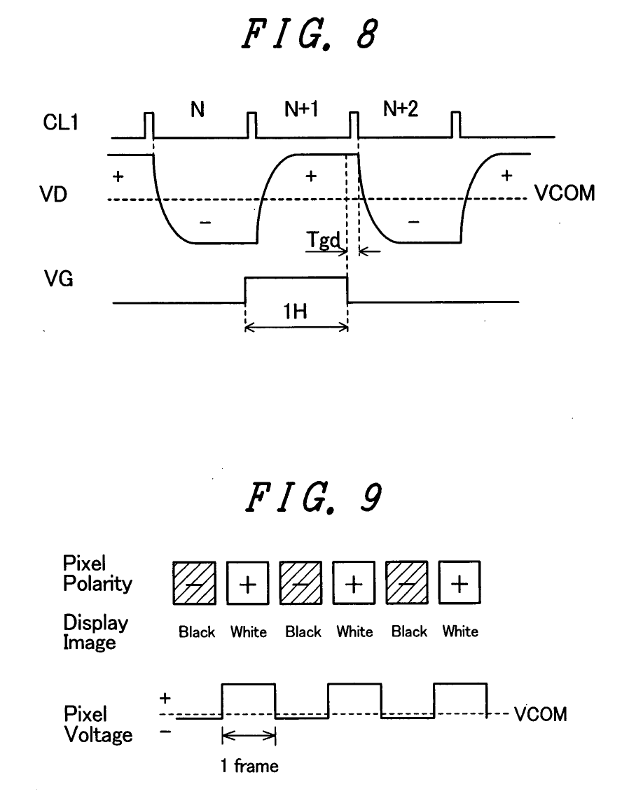

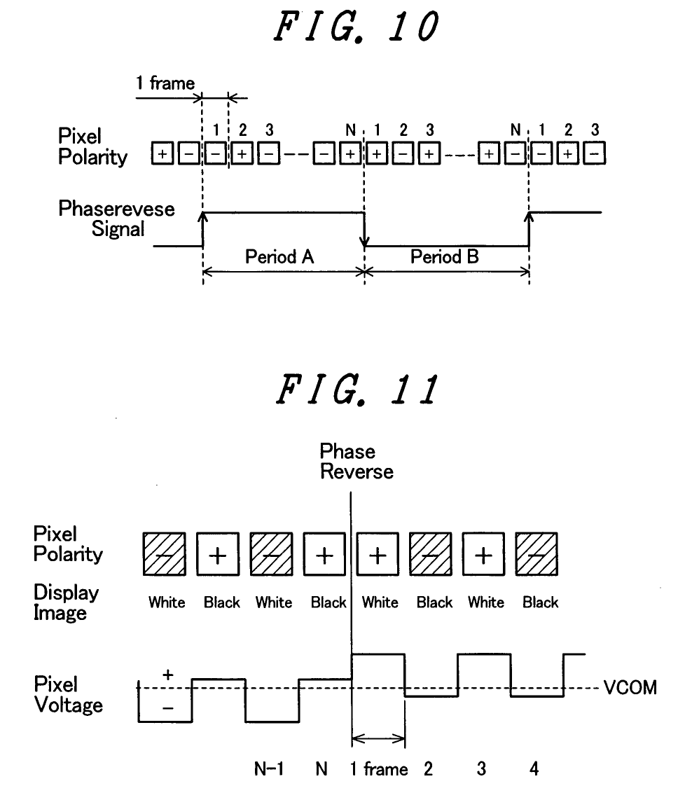

FIG. 1 is a block diagram showing the schematic constitution of a display control circuit 4 of a liquid crystal display module of an embodiment 1 according to the present invention. In the liquid crystal display module of the embodiment of the present invention, the constitution except for the display control circuit 4 (a liquid crystal display panel 1, a gate driver part 2, a source driver part 3 and a power source circuit 5) is equal to the corresponding constitution of the above-mentioned conventional liquid crystal display module shown in FIG. 6 and hence, the repeated explanation is omitted.

In this embodiment, the display control circuit 4 includes a gray scale correction circuit 10, and an EPROM (Erasable and Programmable Read Only Memory) 11 in which a correction quantity of inputted display data is stored. Here, numeral 12 indicates a phase inversion signal.

When there is no change in the phase inversion signal 12, the display control circuit 4 directly outputs the inputted display data to the source driver 3 in a usual manner without applying the correction to the inputted display data.

Further, when the change of the phase inversion signal 12 is detected, the display control circuit 4 reads the correction quantity corresponding to the inputted display data from the EPROM 11 in response to the inputted display data, and applies arithmetic operation processing to the inputted display data thus forming gray scale correction display data, and outputs the gray scale correction display data to the source driver 3.

That is, the display control circuit 4 applies the arithmetic operation processing (subtraction processing) expressed by the following formula (1) to an first frame immediately after the phase inversion in a phase inversion driving method thus forming the gray scale correction display data, and outputs the gray scale correction display data to the source driver 3.

Do=Di−Dr (1)

Here, symbol Di indicates the inputted display data, symbol Dr indicates the correction quantity corresponding to the inputted display data which is stored in the EPROM 11, and symbol Do indicates gray scale correction display data.

FIG. 2 is a graph showing a brightness change quantity of the first frame immediately after the phase inversion in the liquid crystal display module of this embodiment and a brightness change quantity of the first frame immediately after the phase inversion in a conventional liquid crystal display module.

Here, FIG. 2 is a graph showing the brightness change quantity when the display data is 8 bits and driven with 60 Hz, wherein the display gray scale is taken on an axis of abscissas, and brightness change (%) is taken on an axis of ordinates.

Further, in FIG. 2, symbol A indicates the brightness change quantity of the liquid crystal display module of this embodiment, and symbol B indicates the brightness change quantity of the conventional liquid crystal display module. Although the brightness change quantity differs depending on the display gray scale, while the maximal brightness change quantity is 2.5[%] of the conventional liquid crystal display module, in this embodiment, the maximum brightness change quantity is 0.53[%] and hence, it is possible to reduce the brightness change by 78.8(=(2.5-0.53×100/2.5) [%] at maximum.

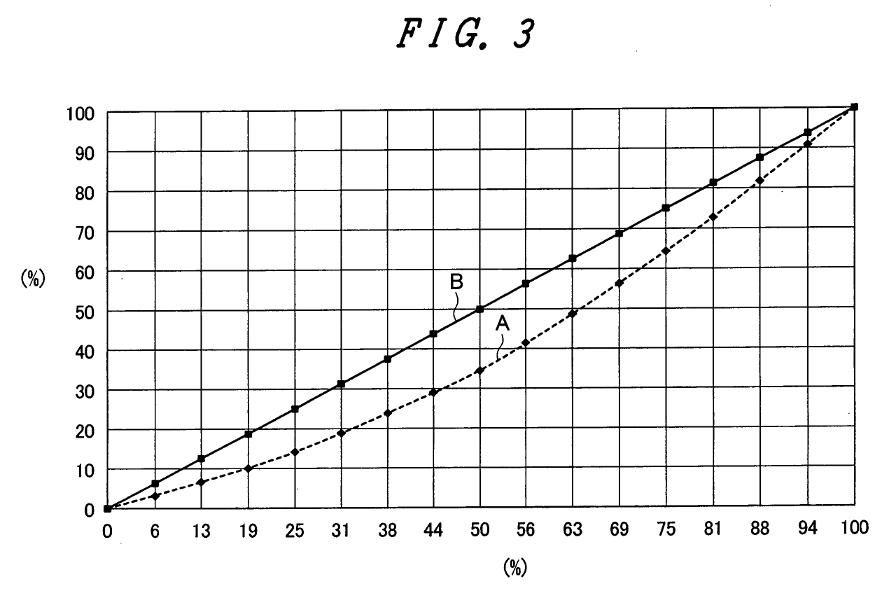

FIG. 3 is a graph showing one example of the relationship between the inputted display data and the gray scale correction display data in the liquid crystal display module of this embodiment.

In FIG. 3, an input gray scale (%) is taken on an axis of abscissas, and an output gray scale (%) is taken on an axis of ordinates, wherein both gray scales are expressed as a ratio with respect to a maximum gray scale. For example, when the maximum gray scale is 256 gray scales, 100 of the input gray scale (%) and the output grayscale (%) indicates 256 grayscales, 25 of the input gray scale (%) and the output gray scale (%) indicates 64 gray scales, 50 of the input gray scale (%) and the output gray scale (%) indicates 128 gray scales, and 75 of the input grayscale (%) and the output grayscale (%) indicates 192 gray scales.

Further, in the graph shown in FIG. 3, symbol A indicates the gray scale correction display data outputted at the time of phase inversion, and symbol B indicates inputted display data which is usually outputted.

As can be understood from FIG. 3, the gray scale correction display data (A in FIG. 3) is display data corresponding to the voltage of gray scale lower than the gray scale corresponding to the inputted display data (Bin FIG. 3). It is also understood that the difference between the inputted display data and the gray scale correction display data is large with respect to the display data of intermediate gray scales compared to the display data of high gray scale or low gray-scale.

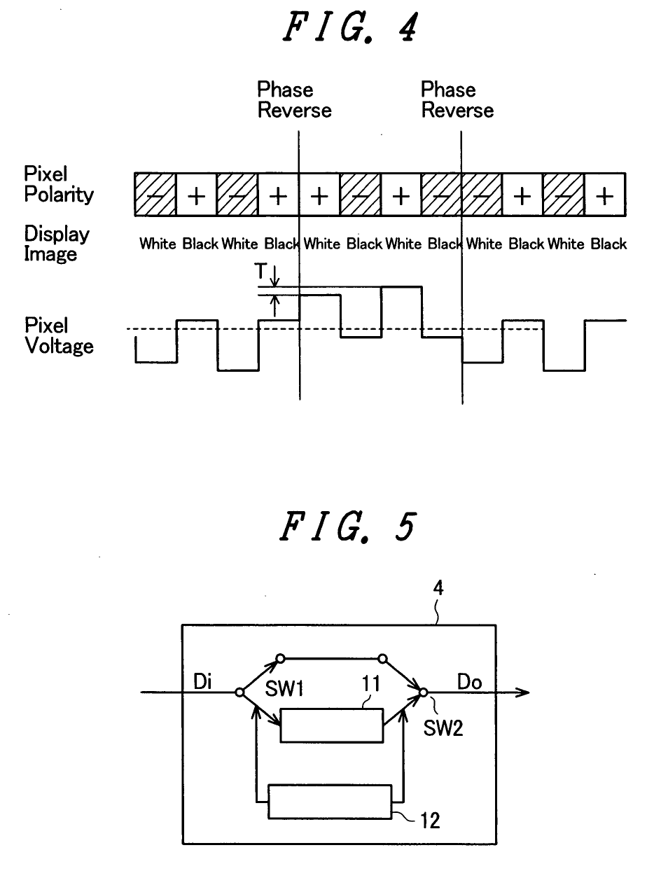

FIG. 4 is a view which schematically expresses the pixel voltage and the pixel polarity of one pixel for every frame with respect to video voltages of white and black in the liquid crystal display module of this embodiment. Here, also in FIG. 4, the explanation is made on a premise that the liquid crystal display panel 1 is operated in a so-called normally black-displaying mode in which the larger the video voltage supplied to the respective pixels, the higher brightness is obtained.

In alternately displaying white and black for every frame, when the phase inversion driving is performed for every N frames, there may be a case that the pixel polarity continues such as “[(−)→(−)]” or “[(+)→(+)]” depending on the changeover timing of the phase inversion.

In this embodiment, as shown in FIG. 4, when the pixel polarity continues as “[(−)→(−)]” or “[(+)→(+)]” by a phase inversion driving method, in the first frame after the phase inversion changeover, the pixel voltage is set lower than the usual voltage as indicated by T in FIG. 4.

Due to such an operation, as described above, it is possible to prevent the occurrence of flickers (elevation of brightness) and, reduce the effective DC voltage applied to the liquid crystal.

### Embodiment 2

FIG. 5 is a block diagram showing the schematic constitution of a display control circuit 4 of a liquid crystal display module of an embodiment 2 according to the present invention.

In the above-mentioned embodiment, the display control circuit 4 applies the arithmetic operation processing (subtraction processing) of the above-mentioned formula (1) to the first frame immediately after the phase inversion in the phase inversion driving method thus forming the gray scale correction display data and outputs the gray scale correction display data to the source driver 3.

To the contrary, in this embodiment, the gray scale correction display data corresponding to inputted display data for respective gray scales is stored in the EPROM 11, wherein when the change of the phase inversion signal 12 is detected, the display control circuit 4 changes over a signal path using switches (SW1, SW2) or the like, the gray scale correction display data corresponding to the inputted display data is read by the EPROM 11, forms the gray scale correction display data, and outputs the gray scale correction display data to the source driver 3.

Further, also in this embodiment, when there is no change of a phase inversion signal 12, the display control circuit 4 directly outputs the inputted display data to the source driver 3.

Here, in this embodiment, the video voltage applied to the pixel is adjusted by changing a data value of the display data (that is, display gray scale) and hence, a level at which the correction can be made differs depending on the numbers of the display gray scales (number of bits of display data).

Although the explanation has been made with respect to the case in which the display data has 256 gray scales of 8 bits heretofore, by adopting the display data having 1024 gray scales of 10 bits, it is possible to perform the correction more finely and hence, it is possible to further lower the change of brightness.

Here, with respect to the liquid crystal display module used in a TV product or the like, in the liquid crystal display module having an overdrive function, an EPROM is already mounted on the liquid crystal display module to allow the EPROM to store set values of the overdrive. Accordingly, in such a case, it is possible to execute this embodiment only with the modification of a logic circuit in the inside of the display control device and hence, it is possible to cope with flickers without increasing the number of parts.

Further, the present invention has been explained in conjunction with embodiments in which the present invention is applied to the liquid crystal display module which adopts the common symmetrical method (for example, dot inversion method) which sets the voltage of the counter electrode (ITO2) to a fixed value as the AC driving method heretofore. However, the present invention is not limited to such embodiments, and the present invention is applicable to a liquid crystal display module which adopts a common inversion method (for example, a 1 line inversion method) in which the voltage of the counter electrode (ITO2) is changed between a voltage of H level and a voltage of L level as an AC driving method.

Further, in the present invention, the type of the liquid crystal display panel is not limited. That is, the present invention is applicable to a liquid crystal display panel of an IPS type, a VA type, a TN type or the like.

Although the invention made by inventors of the present invention has been specifically explained in conjunction with the embodiments, it is needless to say that the present invention is not limited to the above-mentioned embodiments and various modifications are conceivable without departing from the gist of the present invention.

What is claimed is:

1. A liquid crystal display device comprising:
a liquid crystal display panel having a plurality of pixels; and
a drive circuit which drives each pixel out of the plurality of pixels, each pixel including a pixel electrode and a counter electrode, wherein assuming a state in which a video voltage of a potential higher than a potential of a counter voltage applied to the counter electrode is applied to the pixel electrode as a drive state of positive polarity and a state in which the video voltage of the potential lower than the potential of the counter voltage applied to the counter electrode is applied to the pixel electrode as a drive state of negative polarity, the drive circuit changes the drive state of each pixel, for every m(m≧1) frame, from the drive state of positive polarity to the drive state of the negative polarity or from the drive state of the negative polarity to the drive state of the positive polarity and, at the same time, inverts a phase of the drive state of each pixel for every N (N>m) frame, wherein the drive circuit outputs gray scale correction display data which differs from inputted display data in the first frame immediately after the phase inversion.

2. A liquid crystal display device according to claim 1, wherein the gray scale correction display data is display data corresponding to gray scales lower than gray scales corresponding to the inputted display data.

3. A liquid crystal display device according to claim 2, wherein the difference between the inputted display data and the gray scale correction display data is set such that the display data of intermediate gray scales is larger than the high gray-scale display data or low gray-scale display data.

4. A liquid crystal display device according to claim 1, wherein the liquid crystal display device includes a memory for storing a correction quantity for every inputted display data, and the drive circuit generates and outputs the gray scale correction display data by subtracting the correction quantity stored in the memory from the inputted display data.

5. A liquid crystal display device according to claim 1, wherein the liquid crystal display device includes a memory which stores the gray scale correction display data for every inputted display data, and the drive circuit generates and outputs the gray scale correction display data by reading the gray scale correction display data corresponding to the inputted display data from the memory.

6. A liquid crystal display device according to claim 4, wherein the memory is an EPROM.

7. A liquid crystal display device according to claim 1, wherein the “m” is 1.

8. A liquid crystal display device according to claim 1, wherein the counter voltage applied to the counter electrode is a fixed voltage.

9. A liquid crystal display device according to claim 1, wherein the liquid crystal display panel includes a pair of substrates which sandwiches liquid crystal therebetween, and the pixel electrode and the counter electrode are formed on one substrate out of the pair of substrates.
